(19) United States
(12) Patent Application Publication
(10) Pub. No.: US 2007/0255953 A1
(43) Pub. Date: Nov. 1, 2007

(54) Authentication method and apparatus between an internet site and on-line customers using customer-specific streamed audio or video signals

(75) Inventor: Patrice Peyret, Hillsborough, CA (US)

Correspondence Address: DLA PIPER US LLP, 2000 UNIVERSITY AVENUE, E. PALO ALTO, CA, 94303-2248, US

(73) Assignee: Plastyc Inc.

(21) Appl. No.: 11/796,004

(22) Filed: Apr. 25, 2007

Related U.S. Application Data
(60) Provisional application No. 60/795,849, filed on Apr. 28, 2006.

(51) Int. Cl. H04L 9/00

(52) U.S. Cl. 713/168

(57) ABSTRACT

An authentication system and method between an online service provider accessible via public data networks and end users is provided that has an enrollment system allowing end users to define one or several personal sequences of audio or video content, which the online service provider will stream back selectively to the end users during subsequent access by the end users to the online service provider.

### PRIORITY CLAIMS

This application claims priority under 35 USC 119(e) and 120 to U.S. Provisional Patent Application Ser. No. 60/795,849, filed on Apr. 28, 2006 and entitled “Authentication Method and Apparatus Between an Internet Site and On-Line Customers Using Customer Specific Streamed Audio or Video Signals” which is incorporated herein by reference.

### FIELD

An online information services system requiring strong authentication between the service provider and its end users, where the credentials of both the service provider and its end users are reinforced in order to prevent fraudulent impersonation of the service provider by attackers wishing to fool end users into believing that they are accessing a legitimate online site, and to prevent fraudulent impersonation of end users by attackers wishing to fool the service provider into believing that it is being accessed by legitimate end users.

### BACKGROUND

Online services accessible via a public data network like the Internet are commonplace, allowing users to conduct a variety of transactions such as making reservations for services, paying for goods and services, or retrieving information with various levels of accessibility, from strictly private to entirely public. FIG. 1 shows a typical system where an End User 100 accesses a remote service provider 140 via a network 120 such as the Internet, using some kind of computing device (not shown) with sufficient processing power, memory and connectivity to access the network and interact with the remote service provider, such as for example, a personal computer, a mobile phone with browsing capabilities, a terminal, a PDA, a wireless email device, etc. Some online services may store and process highly personal and private information, such as bank or credit card accounts, and therefore implement access-control mechanisms involving user authentication methods and protocols to ensure that information is only accessed by the legitimate viewers. By using end-to-end encryption techniques such as Secure Socket Layers (“SSL”), user credentials such as user names and passwords used for authentication, are protected against interception attacks that may be attempted somewhere along the public data networks between the end users and the service providers. However, attackers sometimes attempt to capture the users' credentials by creating fake web sites that look very similar to the original service providers' web sites, in the hope that end users will not notice the impersonation and will volunteer the presentation of their credentials. Such attacks are widely known as “phishing” attacks. Once an attacker captures the credentials of an unsuspecting user, they can be presented by that attacker to the legitimate online service provider site in order to access further data about the user and perpetrate additional mischief including identity theft, illegitimate payments or funds transfers.

In theory, end users could verify the identity of online service providers before they present their credentials for authentication, by scrutinizing the numeric Internet Protocol (“IP”) address of the site accessed by their Internet browser or the alphanumeric alias of such address, called the Universal Resource Locator (“URL”). However, in practice, the IP address or URL of a site is not displayed prominently by commercial browsers and is too cryptic anyway for casual users to interpret correctly. For example, users would typically have difficulties parsing which among the following URLs is likely to be legitimate: http://www.mybank.com, http://www.my-bank.com, http://www.verifysecurity.com/mybank/authenticate.html Therefore, most users rely only on the familiar graphics layout and content of web pages they expect to see in order to recognize the service provider, even though such layout and graphics can easily be mimicked by attackers.

Conventional techniques to solve the phishing problem can be divided broadly into three categories: third party certification, phishing specific tools, and direct authentication. The typical Third-Party Certification systems use Public Key Infrastructures (PKI) where Certificate Authorities (CAs) vouch for the identity of a service provider by binding a public key to the service provider's credentials in a digital certificate. The SSL protocol and Transport Layer Security (“TLS”) are both based on PKI. In the typical use of SSL with today's browsers, only the server is authenticated, by obtaining an SSL server certificate that is signed by a trusted CA. FIG. 2(a) shows a typical system with the Service Provider 140 having received a signed Certificate 185 from a Certificate Authority 180. As with the URL and IP addresses described above, it also difficult for users to understand and verify SSL server certificates. Some phishers have registered a real SSL certificate for their rogue phishing sites that have a name confusingly similar to a legitimate site. In order to detect this attack, users must be able to inspect the certificate and to distinguish the domain name of the real website from the rogue site. There are also known examples where the CA certificate issuing process has been subverted by individuals managing to make fraudulent identity claims in order to get certificates issued to them.

Herzberg and Gbara have proposed the use of “TrustBars” which use a fixed area at the top of the browser window (the Trusted Credentials Area, or “TCA”) to display validated logos or names, of the web site owner and of the authority that identified the owner of the site. This is also a Third Party Certification mechanism where the site's public key is bound to the graphics logo of the service provider by signing both of them in a certificate, and using the SSL/TLS protocols to validate that the site has the private key corresponding to the public key. Unlike standard SSL/TLS-based browsing, this solution does not rely on end users recognizing small and sometimes confusing security indicators like a padlock at the bottom of the screen. However, because company logos are fixed, they can be easily copied and the TCA can be spoofed. For example, an attacker can present an image of the TCA, with the correct logos, inside an un-trusted page to make it appear legitimate. Also, phishers may attempt to register logos that can be confused with legitimate logos. Therefore, the strength of this proposal depends on the strength of the credentials registration process and of the design of the TCA.

An improvement over standard SSL/TLS consists of seal programs such as the one offered by VeriSign or TRUSTe, which allow certified parties to display a graphical “seal of approval” on their website. Visitors can click on the seal to view a pop-up window that contains information about the website's SSL certificate and identity. However, phishers can spoof this seal by copying the image into their own rogue websites. Some phishers could also simulate the pop-window by hosting it on their own server, while many users would not detect that window does not originate from the Certification Authority.

Anti-Phishing Specific Tools include an Accountguard toolbar extension by eBay Inc.®, the Spoofguard browser plug-in and the Spoofstick toolbar extension. Those tools all attempt to help end users with the correct interpretation of the URL of the visited websites and with identifying whether a visited site is likely to be illegitimate without requiring direct input from end users as with direct authentication schemes. FIG. 2(b) shows a typical system where the End User 100 has installed a tool 108 received from Service Provider 140 to help him/her discriminate the genuine service provider from rogue sites.

The Accountguard tool recognizes eBay and Paypal legitimate websites by displaying a green tab; the tab turns red when a site known to be a spoof site for eBay or Paypal is visited. Users can also submit to eBay the URLs of new sites that they suspect may be rogue. Evidently, the system is limited to sites that eBay and its contributing users can inventory and recognize as rogues.

The SpoofGuard plug-in warns users when visited websites have a high probability of being rogue, based on the analysis of URLs, images and links, and comparisons with previously captured characteristics of legitimate visited web sites and known rogue web sites. The main weakness of SpoofGuard is that the checks performed by the tool can be evaded relatively simply by making minor changes to spoofed websites.

The Spoofstick toolbar extension provides user-friendly information about the domain name of the website. For example, if the user is visiting MyOwnBank, the toolbar displays “You're on myownbank.com” whereas if the user is at a spoofed site, the toolbar might instead display “You're on 117.22.30.6”. This toolbar can help the user detect attacks where phishers create domain names which look confusingly similar to a legitimate domain name. The user can customize the appearance of the toolbar in order to prevent the toolbar itself from being spoofed.

Typical Direct Authentication systems allow servers to be identified directly by users without involving a third party. FIG. 2(c) shows a typical system where End User 100 and Service Provider 140 can authenticate each other by verifying a secret 105. Typical implementations of a Direct Authentication scheme have been proposed by Passmark and Verified by Visa, where the user provides the server with a shared secret during enrollment, such as an image or passphrase, in addition to his or her regular password. The server presents the user with this shared secret, and the user is asked to recognize it before providing the server with his or her password. The most obvious weakness of this scheme is that the service provider must display the shared secret in order to authenticate itself to the user. If the secret is observed or captured, the image or passphrase can be replayed by a phisher until the user notices and changes it.

An improvement over shared-secret based Direct Authentication Schemes has been proposed by Dhamija and Tygar, in the form of Dynamic Security Skins (“DSS”). In DSS, a user-selected picture is used as semi-transparent background for the window where the password capture field is displayed, thus creating a “trusted window”. In addition, a session-specific graphics pattern is computed by the server and inserted in other parts of the web page, for example as background to sensitive parts of the page, where the pattern is derived mathematically from the result of a hash function performed in the last step of a modified implementation of the verifier-based Secure Remote Password protocol (“SRP”) developed by Wu. The user's computing device also computes the same session-specific graphics pattern using SRP, and displays the result as a border around the trusted window. By comparing the graphics pattern around the background picture in of the trusted window with the graphics patterns displayed in other parts of the page, the end user can both verify that the server knows his/her selected picture and that the picture is not being displayed by a rogue site that would be unable to compute the proper graphics pattern.

Some other typical Direct Authentication schemes like Petname proposed by Close and available for the Mozilla browser or Synchronized Random Dynamic Boundaries (“SRD”) proposed by Ye and Smith use only client-side secrets which do not need to be shared with a remote server. Petname lets the user assign an arbitrary name or sequence of characters to a visited SSL-certified website; subsequent visits to this web site will trigger the browser equipped with the Petname add-on to display the chosen name or sequence of characters to the user and to display an “un-trusted” warning in case the website is not recognized. The security of Petname depends on users choosing non-obvious petnames, and on the ability of users to keep their client computers free from spyware programs that could attempt to capture the chosen petnames in order to perpetrate a subsequent phishing attack.

SRD relies on the user's browser choosing a random rate for blinking the boundaries of windows recognized as trusted, and displaying a reference blinking area to the user in order to let him or her recognize the trust placed in the visited website. The strength of this scheme relies on the difficulty for an illegitimate website to guess at which rate it should blink its own borders in order to fool users.

In summary, Third Party Authentication based systems rely on users being able to discriminate genuine URLs, certificates, logos or seals generated by central authorities in spite of their various degrees of vulnerability to spoofing. Although these systems can be improved, they will inevitably be caught in an arms race between certifiers and attackers respectively for the creation and imitation of user-recognizable proofs. In addition, improvements are necessarily constrained by the need for keeping the proofs simple and easy for end users to recognize.

The anti-phishing specific tools require the installation of specific software on the end user's computer, such as browser toolbars or plug-ins. This limits the protection to only the main computer of the user, for example at home, and leaves the user unprotected when logging in from a friend's place or an Internet café.

The Direct Authentication Systems can be simpler because they do not require a third party authority and may not require specific client software when they are based on shared secrets. However, they are vulnerable to the interception by spyware or otherwise of pictures and pass-phrases used as shared secrets.

None of the known anti-phishing systems allows users to verify the authenticity of solicitations inside email messages, whereas email messages containing fraudulent links are the main vehicle for initiating phishing attacks. In addition, none of the anti-phishing systems described of the background art can be extended easily to also reinforce the authentication of the end-user by the server: they would involve the deployment of complex client-side infrastructure such as user SSL certificates or additional browser software, or even additional hardware such as tokens or biometric devices.

There is thus a need for, and it would be advantageous to have, risk-reduction methods and apparatuses enabling end users to be protected against phishing attacks without requiring support from Third Party Certification Authorities, without client-side software, while being immune to the interception of user-selected secrets during their presentation to end users, while enabling the authentication of email messages, and also enabling servers to strongly authenticate end users if required.

### SUMMARY

A system, apparatus and method are provided that improve the security of interactions between online service providers and end-users over public data networks. The system may provide a direct authentication mechanism that allows an end user to ascertain the authenticity of a Service Provider's remote server based on a shared secret. In an implementation of the system, the shared secret may be a user-selected collection of audio or video segments of a few seconds each concatenated to form a contiguous sequence of a duration sufficient for the user to later recognize the sequence upon listening to it or watching it while being long enough to prevent an attacker from creating successfully a spoofed sequence by guessing or trial-and-error.

The shared secret is generated by the user during an initial enrollment process whereupon the user is invited to create an audio-video sequence consisting of segments available from a remote server hosting a large enough choice of audio and video sequences to choose from, and/or generated locally by the user. When a remote server is used as a source of available audio or video sequences for generating the shared secret, then this server can be the same as or different from the service provider's server to be later authenticated by the user.

The shared secret is played back to the user by the service provider's remote server through digital streaming using existing protocols of the background art, preferably encrypted end-to-end to prevent interception, after the unique identifier of the user, such as a user name, has been recognized by the service provider's remote server, either automatically after such recognition once the user has typed his/her user identifier or once the server has recognized an identification cookie in the user's browser, or upon explicit request of the user, for example when the user clicks on a button of the log-in page.

The shared secret can optionally be played back to the user from within email messages sent by the genuine service provider to the end user by letting the user click on a dedicated link other than the link back to the service provider web site

The shared secret is optionally diversified by mixing it with a variable audio or video track generated locally by the remote server before being streamed back to the user in order to introduce an element of variability in the stream and avoid computer-based interception and replay attacks, while still making it possible for the user to recognize his or her chosen audio/video sequence. By way of example, the variable track can be a voice uttering the current date and/or time.

The shared secret can be changed from time to time at the request of the user. In addition, the system and method may provide a system where a direct authentication mechanism in the reverse direction is optionally implemented allowing the same service provider's remote server to ascertain the authenticity of end users based on a second shared secret. The second shared secret is a long password or pass-phrase created by the user through indirect association with the first shared secret consisting of a user-selected audio/video sequence, in such a way that the user will be able to remember his or her second secret by listening to or watching the first secret, but it will be very difficult for attackers to mount a dictionary attack on the second secret even if the first secret was compromised. By way of example, a user could associate names of friends having introduced them to the music or artist, names of locations where videos where shot, memorable dates of parties when they heard the music for the first time, code-words related to the artist or music titles, etc. and concatenate those together to generate their long password or pass-phrase. The second shared secret can be used as the main password of the user or as a second password in a two-factor authentication sequence, after a “regular” main password has been presented by the user.

During such subsequent accesses, end users can convince themselves that they are accessing the original and legitimate online service provider by recognizing the streamed audio or video sequence as being the sequence they personally defined at enrollment time. In order to prevent interception and replay attacks, the server can mix into the audio part of the streamed sequence a variable voiceprint for example uttering the current date and time. End users can also change their personal audio or video sequence from time to time. Additionally, end users may choose to associate a string of key words or successions of letters or symbols with each element of their personal audio or video sequence, in such a way that the listening to or watching of such personal audio or video sequence will remind them of the chosen string of words, letters or symbols. Such string can then be used by end users as a very long password to authenticate themselves to the online system provider, either as their main password, or as a second password to implement a two-factor authentication protocol.

### BRIEF DESCRIPTION OF THE DRAWINGS

FIG. 1 is a simplified block diagram describing a typical remote interaction between an end user and a service provider over the Internet;

FIG. 2 is a depiction of the three typical system architectures used to combat anti-phishing;

FIGS. 3a and 3b are simplified block diagram showing an embodiment of a system and method for permitting an end user to enroll and then authenticate a service provider, respectively;

FIG. 4 is a simplified block diagram showing another embodiment of the system and method that derives a secret pass-phrase from the stream-able Audio/Video secret that can used for authenticating a service provider;

FIG. 5 is a simplified flowchart describing the operation of an information system when a user attempts to log-in to a remote service provider via a browser and the Internet and wants to check the authenticity of the website; and

FIG. 6 is a simplified flowchart describing the operation of an information system when a User receives a service email from a remote service provider and wants to check the authenticity of the email.

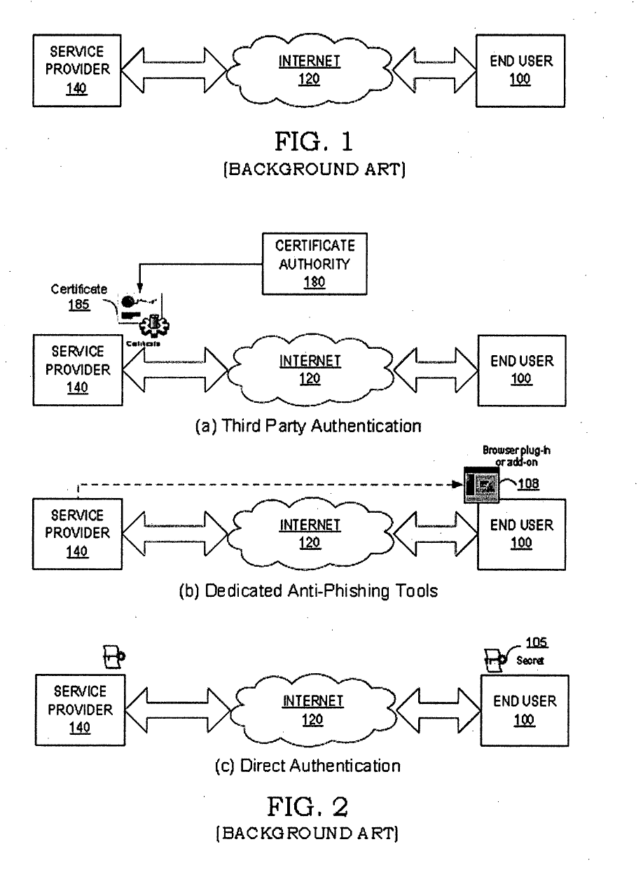

### DETAILED DESCRIPTION OF EMBODIMENTS OF THE SYSTEM AND METHOD

The system and method are particularly applicable to a software/hardware implemented web-based authenticating system and it is in this context that the system and method will be described. It will be appreciated, however, that the system and method have greater utility since the system and method can be used with other non-web-based systems and with any system in which it is desirable to prevent phishing attacks and may be implemented in hardware or in software.

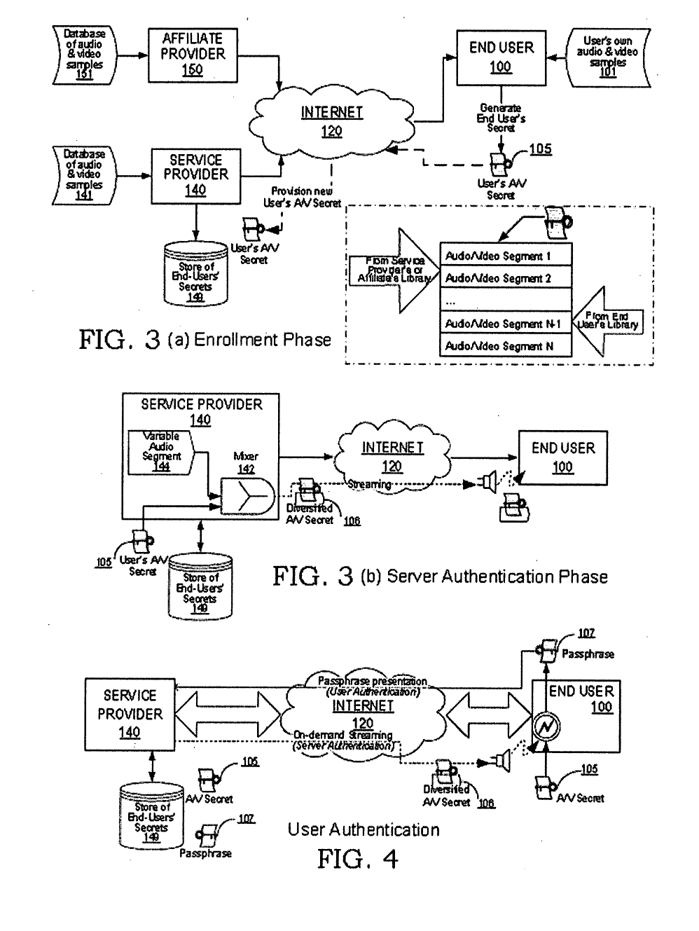

The system and method described below provides an end user 100 with the ability to verify, from time to time, the authenticity of a remote service provider 140 in order to thwart phishing attacks wherein the system implements an enrollment method shown in FIG. 3a and a server authentication phase/method as shown in FIG. 3b. The end user 100 may have a computing device with sufficient processing power, memory and connectivity to connect to and interact with the service provider 140 or an affiliate provider 150. The computing device may be, for example, a personal computer, a laptop computer, a palmtop computer, a PDA with digital data capabilities, a mobile phone with digital data capabilities, a cable television set-top box and the like. The processing unit of the computing device may execute a known browser application, such as Microsoft Explorer, to connect to and interact with the service provider 140 or the affiliate provider 150. During an enrollment phase described in FIG. 3a, the user 100 may generate a user's A/V Secret 105 by assembling content segments from a variety of possible sources including: Segments 101 already owned or generated by the User himself or herself; Segments 141 obtained from the remote service provider 140 via a network 120, such as the Internet in the example of the system shown in FIGS. 3a and 3b; and/or Segments 151 obtained from an affiliate remote provider 150 via the network 120. An non-exhaustive list of the different types of segments used by the system includes a few seconds of pre-recorded music, a few seconds of the user's face and voice captured via a webcam, a sound effect available from the operating system of the user's computer. The service provider and affiliate provider 140, 150 are typical web-based systems with one or more servers, a database, etc. that are able to provide the segments of content to the user 100. The segments of content may be, for example, segments of audio data and/or visual data. Each segment used for the assembly of User's A/V Secret 105 may be less than 30 seconds in duration to comply with copyright restrictions, if such segments happened to be the subject of a third party copyright, although the system can be implemented with segments that are longer than 30 seconds. As shown, one or more content segments, such as segment 1, segment 2, segment N-1 and segment N in the example shown in FIG. 3a, may be combined together from the one or more possible sources to form the user A/V secret 105. The user's A/V Secret 105 may be then uploaded via the network 120 to the remote service provider 140 using a well known protocol, such as SSL. The protocol may provide end to end encryption to prevent interception, but the system also may be implemented with protocol that does not support end to end encryption. The uploaded user A/V secret 105 may then be stored in a data repository 149, such as for example a database store, that is associated with the service provider 140. In normal operation, the data repository 149 may include a plurality of user A/V secrets 105 so that the service provider 140 can be authenticated by each user with his/her own A/V secret 105.

During a subsequent authentication phase illustrated in FIG. 3b, the user 100 ascertains the authenticity of the remote service provider 140 by requesting that the service provider 140 stream the A/V Secret 105 for the particular user to the user 100 over the network using a known protocol, such as SSL, that may provide end to end encryption to prevent interception, but may also operate without end to end encryption. The request for the A/V secret 105 by the user may be: automatically generated after user 100 has entered his or her user identifier in a log-in page displayed by remote service provider 140; automatically generated when the remote service provider 140 recognizes a browser cookie inside the user's computing device and/or browser that uniquely identifies the user 100; generated manually by the user 100 clicking on a special button displayed by remote service provider 140 in a web page that is displayed in a browser window of the computing device of the user; and/or generated manually by the user 100 clicking on a link or button displayed inside an email message having been sent by the remote service provider 140.

Once the request for the A/V secret is received from the user 100, the service provider 140 may optionally mix a variable content segment 144 together with the A/V secret 105 via a known content mixer 142 in order to produce a diversified A/V Secret 106, which is then streamed over the network via the known protocol that may be encrypted end to end to avoid interception, but may also operate without end to end encryption, such as https. As humans can easily discriminate acoustically and/or visually between superimposed layers of content material, user 100 can retrieve/extract his or her A/V Secret 105 from the diversified A/V Secret 106, and thus authenticate the remote service provider 140 as the one having received his or her secret in the prior enrollment sequence. In this manner, the remote service provider 140 can be authenticated by each user of the system and each A/V secret 105 for each user will be unique and easily recognizable by each user of the system.

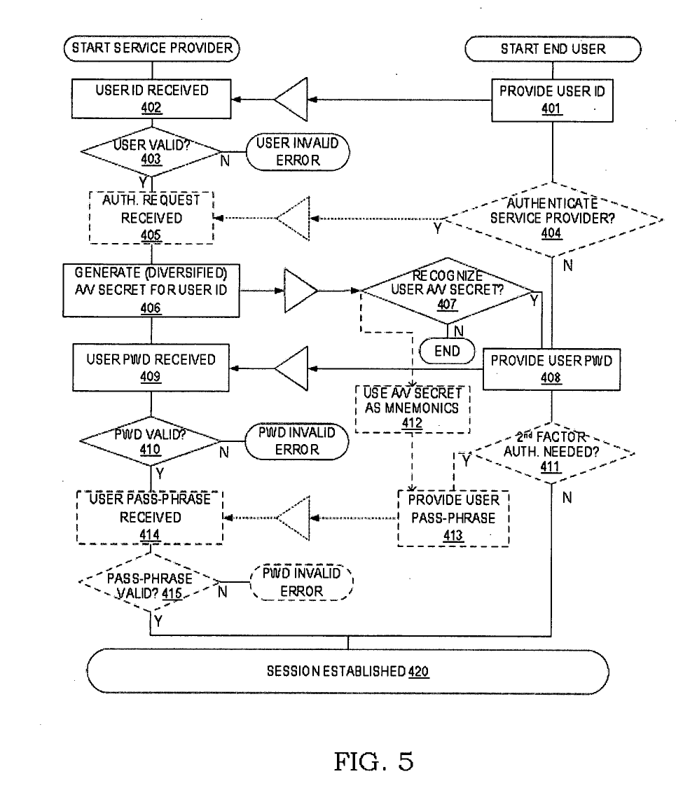

FIG. 4 is a simplified block diagram showing another embodiment of the system and method that derives a secret pass-phrase from the stream-able Audio/Video secret that can used for authenticating a service provider. In this embodiment, the end user 100 is strongly authenticated from time to time by the remote service provider 140 in order to thwart impersonation attacks and/or to generate a strong pass-phrase used as a main or secondary user authentication factor. To accomplish this strong authentication, the user, during an enrollment session, may derive a pass phrase 107 from the A/V Secret 105 wherein the pass phrase may be made from a succession of letters and possibly numbers and alpha-numeric symbols in such a way that the A/V Secret 105 constitutes a visual and auditory mnemonic that will later help the user 100 remember the Pass-Phrase 107. By way of example, the Pass-Phrase 107 can be built by User 100 by concatenating together the first three letters or the title of each song that has been used to build User's A/V Secret 105, if 105 consists of a succession of songs known to the User. Another example of a Pass-Phrase 107 can be the concatenation of the words of the verse of a poem following the verse uttered by User 100 inside his or her A/V Secret 105. Yet another example of a Pass-Phrase 107 can be the concatenation of the album title, year of release, and location-of-purchase, of a piece of music inside A/V Secret 105. The exact form of the Pass-Phrase 107 is not important as long as the User is confident that he or she will be able to remember it when listening to or watching A/V Secret 105 in case he or she has forgotten the Pass-Phrase.

Subsequent to the enrollment session, after the pass-phrase 107 for user 100 has been created and uploaded securely into Store 149 of remote service provider 140, user 100 can authenticate himself or herself to the remote service provider 140 by presenting the pass-phrase 107 to the service provider 140 using a known protocol, that may provide end to end encryption but may also not provide end to end encryption, over the network 120. If the user 100 needs to be reminded securely of the pass-phrase. 107, the user 100 can request the streaming of the AV Secret 105 or Diversified AV Secret 106 associated with the user from the remote service provider 140, as a mnemonics means of remembering the pass-phrase 107 while simultaneously authenticating the remote service provider 140.

It will be appreciated that the applicability of certain options for the A/V secret 105 and pass phrase 107 depend on the availability of a typical speaker or audio headset to end user 100, typically built in a personal computer or connected to the audio output connector of a personal computer used for Internet access. Nevertheless, in other possible embodiments, the end user 100 may be accessing the remote service provider 140 through a mobile phone, cable television set-top box, or other apparatus of the background art capable of a connection to the Internet in which case certain types of A/V secret 105 may be unavailable to use by the user. Therefore, the system may permit the user to generate more than one A/V secret 105 wherein one A/V secret may be used with computing devices that have a speaker or audio headset while another A/V secret may be used with computing devices, such as the cable set-top box, that does not have the audio capabilities.

FIG. 5 is a simplified flowchart describing the operation of an information system when a user attempts to log-in to a remote service provider via a browser and the Internet and wants to check the authenticity of the website. To begin, the user provides his user identification to the service provider (401, 402). This is typically an alphanumeric user name, or could be a mobile phone number or an email address. The Service Provider may then determine if the User ID is valid and enters into some error processing step if not (403). The user, optionally, may then explicitly request an authentication from the service provider before going any further (404, 405) although the service provider can decide to authenticate itself without an explicit request from the user. The service provider then retrieves the A/V Secret 105 associated with the user and optionally diversifies it into a Diversified A/V Secret 106 (406), and the streams it to the End User. The user then listens to and/or watches the (optionally diversified) A/V Secret and decides whether or not he or she recognizes it as his or her genuine secret (407). If the recognition fails, then the user typically decides to go no further as the remote service provider might be a phishing site. If the recognition is successful, then the user can provide his or her password to the service provider (408, 409). This is typically done through a typical method where a string of alphanumeric characters and symbols is entered in a field of the displayed browser page or a daughter window of the browser. The service provider may then determine if the user password is valid (410) and enters into some error processing step if not. The system may optionally then require a second factor authentication of the user by way of a pass-phrase which is typically longer than a password, and less prone to dictionary attacks (411-415). During this optional process, the user enters his or her pass-phrase which can be inferred, if necessary, from the A/V Secret received in step 407 above (412,413). The service provider then determines if the user pass-phrase is valid and enters into some error processing step if not (414,415). Once the user and service provider have cross-authenticated each other (using the A/V secret and the pass phrase), a session between the user and service provider is established and the remainder of the session can proceed (420).

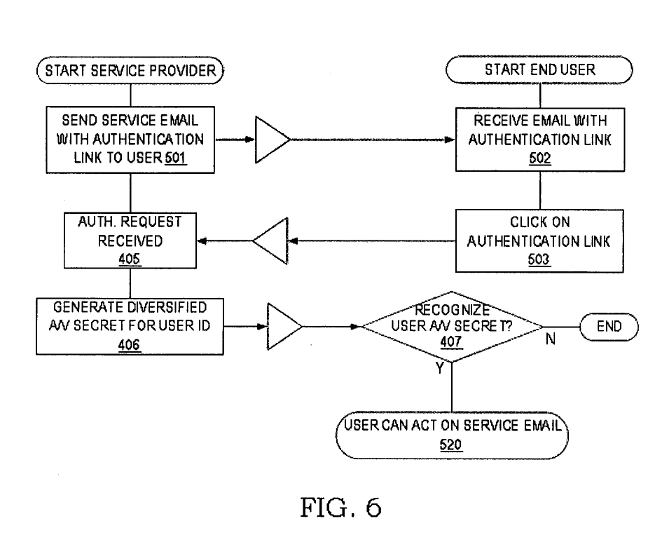

FIG. 6 is a simplified flowchart describing the operation of an information system when a User receives a service email from a remote service provider and wants to check the authenticity of the email. To begin, the service provider distributes a service message, such as an email message, where the service provider sends an email message to the user through some email server. By way of example, such a service message can be a notification to the user about some change in the service and an invitation for the user to follow a service link embedded in the email message to check the terms and conditions of the new service items. In addition to service links, the service provider has also inserted in the email message a unique authentication request link that the user will be able to click on to verify the authenticity of the service provider (501,502). The user may then choose to click on the authentication request link before acting further on the email message (503). As described above with respect to FIG. 5 for the browser authentication process, the service provider may, when the authentication request link is selected, retrieves the A/V Secret 105 associated with the user and optionally diversifies it into a diversified A/V Secret 106, and streams it to the user 100 (405, 406). As with the browser authentication, the user may listens to and/or watches the (optionally diversified) A/V Secret and decides whether or not he or she recognizes it as his or her genuine secret (407). If the recognition fails, then the user typically decides to go no further as the originator of the email might be a phishing site. If the recognition is successful, the user can decide to act on the email (520).

While the foregoing has been with reference to a particular embodiment of the system, it will be appreciated by those skilled in the art that changes in this embodiment may be made without departing from the principles and spirit of the system and method, the scope of which is defined by the appended claims.

1. A direct authentication method between an end user and a remote service provider to authenticate the service provider, comprising:
providing a secret consisting of a user-selected collection of content segments concatenated to form a contiguous sequence of content; and
playing, by the service provider, the secret to the user wherein the contiguous sequence of content is of a duration sufficient for the user to later recognize the sequence.

2. The method of claim 1, wherein playing the secret further comprises listening, by the user, to the secret.

3. The method of claim 1, wherein playing the secret further comprises watching, by the user, the secret.

4. The method of claim 1, wherein each content segment further comprises an audio segment or a visual segment.

5. The method of claim 1 further comprising generating, by the user, the secret during an enrollment phase and storing the secret in a data repository associated with the service provider.

6. The method of claim 5, wherein generating the secret further comprises selecting each content segment from content segments available from the service provider or content segments available to the user.

7. The method of claim 6, wherein selecting each content segment further comprises selecting a content segment from a provider that is different from the service provider to be authenticated.

8. The method of claim 1, wherein playing the secret further comprises streaming the secret from a server of the service provider using a digital streaming protocol over a network.

9. The method of claim 8, wherein streaming the secret further comprises encrypting the secret between the user and the service provider to prevent interception of the secret.

9. The method of claim 1, wherein providing the secret further comprising mixing the secret with a variable content segment to generate a diversified secret that is provided to the user, the diversified secret prevents a computer-based interception attach or a replay attack.

10. The method of claim 9, wherein the variable content segment further comprises a voice track uttering a current date and a current time.

11. The method of claim 1 further comprising receiving, from the user, a request for the secret before playing the secret for the user.

12. The method of claim 11, wherein receiving the request for the secret further comprises receiving a request for the secret when the user clicks on an embedded link inside an email message.

13. A direct authentication method between an end user and a remote service provider based on a pass-phrase secret, comprising:
providing a secret consisting of a user-selected collection of content segments concatenated to form a contiguous sequence of content; and
providing a mnemonic of a pass-phrase consisting of a sequence of alphanumeric characters and symbols created by the user, where the characters and symbols in the mnemonic are derived by the user from the secret.

14. The method of claim 13 further comprising storing, at the service provider, the mnemonic and requesting, by the user, the mnemonic from the service provider when the user needs a reminder of the pass-phrase.

15. The method of claim 14 further comprising streaming the mnemonic to the user over a network.

16. The method of claim 15, wherein streaming the mnemonic further comprises encrypting the mnemonic between the user and the service provider to prevent interception of the mnemonic.

17. The method of claim 13 further comprising playing, by the service provider, the secret to the user wherein the contiguous sequence of content is of a duration sufficient for the user to later recognize the sequence.

18. The method of claim 17, wherein playing the secret further comprises listening, by the user, to the secret.

19. The method of claim 17, wherein playing the secret further comprises watching, by the user, the secret.

20. The method of claim 13, wherein each content segment further comprises an audio segment or a visual segment.

21. The method of claim 13, wherein providing the secret further comprising mixing the secret with a variable content segment to generate a diversified secret that is provided to the user, the diversified secret prevents a computer-based interception attach or a replay attack.

22. The method of claim 13 further comprising generating, by the user, the mnemonic during an enrollment phase and storing the mnemonic in a data repository associated with the service provider.

23. The method of claim 22, wherein generating the mnemonic further comprises selecting each content segment from content segments available from the service provider or content segments available to the user.

24. An apparatus for authentication of a service provider to a user, the apparatus comprising:
a service provider system having a data repository, the data repository having a plurality of secrets associated with each user of the service provider, each secret consisting of a user-selected collection of content segments concatenated to form a contiguous sequence of content;
a network;
a user computing device, capable of establishing a session with the service provider over the network; and
the service provider having a plurality of lines of computer code executed by the service provider system, the plurality of lines of computer code playing the secret to the user wherein the contiguous sequence of content is of a duration sufficient for the user to later recognize the sequence.

25. The apparatus of claim 24, wherein playing the secret further comprises listening, by the user, to the secret.

26. The apparatus of claim 24, wherein playing the secret further comprises watching, by the user, the secret.

27. The apparatus of claim 24, wherein each content segment further comprises an audio segment or a visual segment.

28. The apparatus of claim 24, wherein the user computing device further comprises a personal computer, a laptop computer, a palmtop computer, a PDA with digital data capabilities, a mobile phone with digital data capabilities or a cable television set-top box.

29. The apparatus of claim 28, wherein the user computing device further comprises a plurality of lines of computer code executed by the user computing device that generate the secret during an enrollment phase and that stores the secret in the data repository associated with the service provider.

30. The apparatus of claim 29, wherein the user computing device further comprises a plurality of lines of computer code executed by the user computing device that select each content segment from content segments available from the service provider or content segments available to the user.

31. The apparatus of claim 30, wherein the user computing device further comprises a plurality of lines of computer code executed by the user computing device that select a content segment from a provider that is different from the service provider to be authenticated.

32. The apparatus of claim 24, wherein playing the secret further comprises streaming the secret from a server of the service provider using a digital streaming protocol over the network.

33. The apparatus of claim 32, wherein the network further comprises the Internet.
